(19) United States
(12) Patent Application Publication
(10) Pub. No.: US 2005/0187980 A1
(43) Pub. Date: Aug. 25, 2005

(54) Systems and methods for hosting the common language runtime in a database management system

(75) Inventors: Peter Carlin, Seattle, WA (US); Jose A. Blakeley, Redmond, WA (US); Balaji Rathakrishnan, Sammamish, WA (US); Beysim Sezgin, Redmond, WA (US); Mason Bendixen, Kirkland, WA (US); Xiaowei Jiang, Bellevue, WA (US); Aakash Kambuj, Kirkland, WA (US); Alazel Acheson, Redmond, WA (US)

Correspondence Address: WOODCOCK WASHBURN LLP, ONE LIBERTY PLACE - 46TH FLOOR, PHILADELPHIA, PA, 19103, US

(73) Assignee: MICROSOFT CORPORATION

(21) Appl. No.: 10/776,371

(22) Filed: Feb. 10, 2004

(51) Int. Cl. G06F 7/00

(52) U.S. Cl. 707/200

(57) ABSTRACT

The present invention the is directed to systems and methods for hosting the CLR in a DBMS in order to achieve reliability, scalability, security, and robustness for enabled DBMS programming features. Integrating the CLR with a DBMS enables programming features in the database such as stored procedures, functions, triggers, types, and aggregates to be written in any of the programming languages that are compiled into IL code supported by the CLR. For the various embodiments of the present invention, the CLR is hosted inside the DBMS and, instead of making requests directly to the server operating system, the CLR instead interfaces with the DBMS via DBMS APIs for such requests, and only the DBMS directly interfaces with the server operating system to access the server.

### FIELD OF THE INVENTION

The present invention generally relates to the field of database management systems and, more specifically, to hosting the Common Language Runtime (CLR) in a database management system (DBMS).

### BACKGROUND OF THE INVENTION

A database management system (DBMS) is a program that lets one or more computer programs (and the users of those programs) create and access data in a database. The DBMS manages database requests so that the programs are free from having to understand where the data is physically located on the storage media and, in a multi-user system, who else may also be accessing the data. In handling requests, the DBMS ensures the integrity of the data (that is, making sure it continues to be accessible and is consistently organized as intended) as well as its security (making sure only those with access privileges can access the data). The most typical DBMS is a relational database management system (RDBMS), and the standard user/program interface for an RDBMS is the Structured Query Language (SQL).

A DBMS is usually an inherent part of a database product. For example, Microsoft Access is a popular example of a single- or small-group user DBMS, whereas Microsoft's SQL Server is an example of a DBMS that serves database requests from multiple “client” users. Other popular DBMSs—all of which are also RDBMSs—include IBM's DB2, Oracle's line of database management products, and Sybase's products.

The .NET Common Language Runtime (CLR) is an execution platform that manages the execution of intermediate language (IL) code generated from any one of several programming languages, and the CLR allows these different IL code components to share common object-oriented classes written in any of the supported languages—for example, the CLR allows an instance of a class written in one language to call a method of a class written in another language. Moreover, programs compiled for the CLR do not need a language-specific execution environment, and these programs can easily be moved and executed on any system with CLR support.

Programmers developing code in Visual Basic, Visual C++, or C# compile their programs into intermediate language code called Common Intermediate Language (CIL) in a portable execution (PE) file that can then be managed and executed by the CLR. The programmer and the environment specify descriptive information about the program when it is compiled and the information is stored with the compiled program as metadata. This metadata, stored in the CIL compiled program, tells the CLR what language was used, its version, and what class libraries will be needed by the program for execution.

The CLR also provides services, such as automatic memory management, garbage collecting (returning unneeded memory to the computer), exception handling, and debugging, and thus provides a powerful yet easy-to-use programming model. The CLR is sometimes referred to as a “managed execution environment” (MEE), and the IL code that executes within the CLR is called managed code.

Currently a CLR running on a server that also hosts a DBMS is problematic because the CLR can compromise the reliability, scalability, security, and robustness of the DBMS. For example, when operating independently on the same server, both the DBMS and CLR manage memory, threads, and synchronization between multiple threads, and sometimes conflicts can result. Various embodiments of the present invention provides a solution to this problem.

### SUMMARY OF THE INVENTION

The present invention is directed to systems and methods for hosting the CLR in a DBMS in order to achieve reliability, scalability, security, and robustness for enabled DBMS programming features. Integrating the CLR with a DBMS enables programming features in the database such as stored procedures, functions, triggers, types, and aggregates to be written in any of the programming languages that are compiled into IL code supported by the CLR. For the various embodiments of the present invention, the CLR is hosted inside the DBMS and, instead of making requests directly to the server operating system, the CLR instead interfaces with the DBMS via DBMS APIs for such requests, and only the DBMS directly interfaces with the server operating system to access the server.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram representing a computer system in which aspects of the present invention may be incorporated;

FIG. 2 is schematic diagram representing a network in which aspects of the present invention may be incorporated;

FIG. 3A illustrates a DBMS and a CLR running on the same server side by side;

FIG. 3B illustrates a DBMS and a CLR running on the same server where the CLR is running within the same space as the DBMS; and

FIG. 4 illustrates a DBMS hosting a CLR in accordance with several embodiments of the present invention.

### DETAILED DESCRIPTION OF ILLUSTRATIVE EMBODIMENTS

The inventive subject matter is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Computer Environment

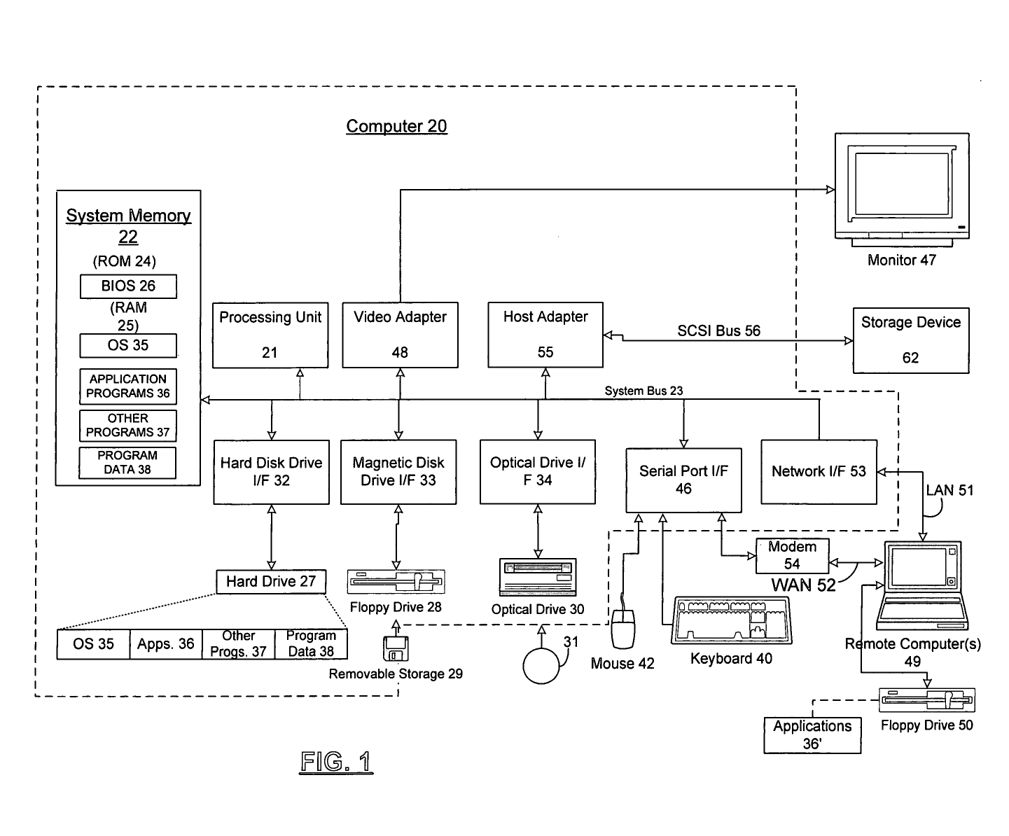

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used. Moreover, while it is envisioned that numerous embodiments of the present invention are particularly well-suited for computerized systems, nothing in this document is intended to limit the invention to such embodiments.

Networking Environment

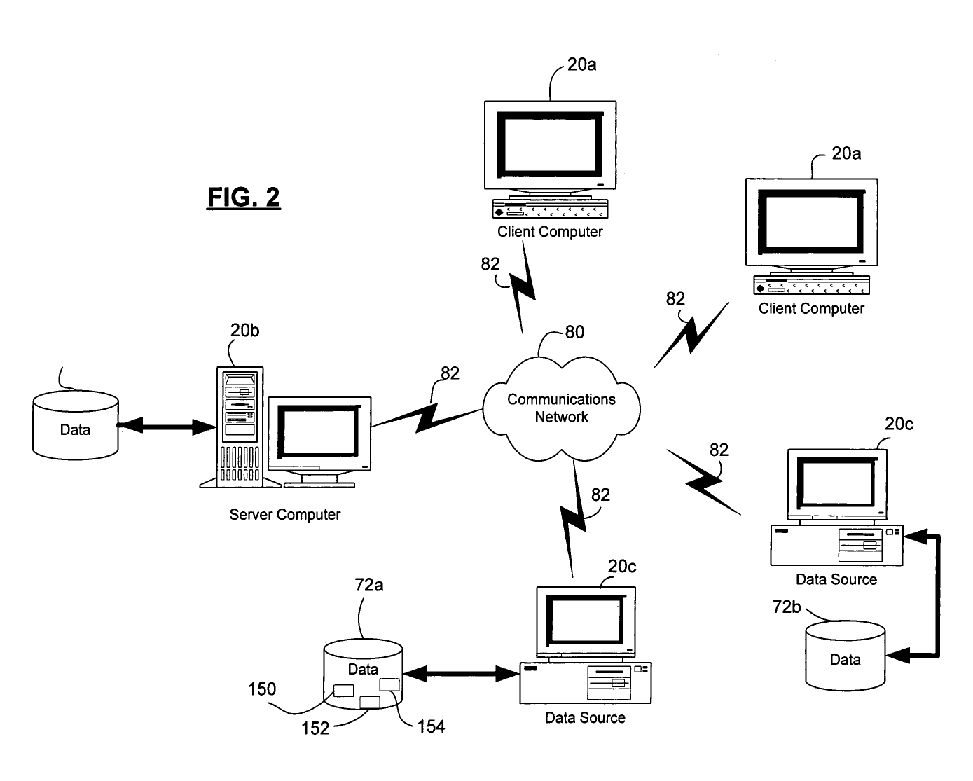

FIG. 2 illustrates an exemplary network environment in which the present invention may be employed. Of course, actual network and database environments can be arranged in a variety of configurations; however, the exemplary environment shown here provides a framework for understanding the type of environment in which the present invention operates.

The network may include client computers 20a, a server computer 20b, data source computers 20c, and databases 70, 72a, and 72b. The client computers 20a and the data source computers 20c are in electronic communication with the server computer 20b via communications network 80, e.g., an Intranet. Client computers 20a and data source computers 20c are connected to the communications network by way of communications interfaces 82. Communications interfaces 82 can be any one of the well-known communications interfaces such as Ethernet connections, modem connections, and so on.

Server computer 20b provides management of database 70 by way of database server system software, described more fully below. As such, server 20b acts as a storehouse of data from a variety of data sources and provides that data to a variety of data consumers.

In the example of FIG. 2, data sources are provided by data source computers 20c. Data source computers 20c communicate data to server computer 20b via communications network 80, which may be a LAN, WAN, Intranet, Internet, or the like. Data source computers 20c store data locally in databases 72a, 72b, which may be relational database servers, excel spreadsheets, files, or the like. For example, database 72a shows data stored in tables 150, 152, and 154. The data provided by data sources 20c is combined and stored in a large database such as a data warehouse maintained by server 20b.

Client computers 20a that desire to use the data stored by server computer 20b can access the database 70 via communications network 80. Client computers 20a request the data by way of SQL queries (e.g., update, insert, and delete) on the data stored in database 70.

Hosting the CLR in the DBMS

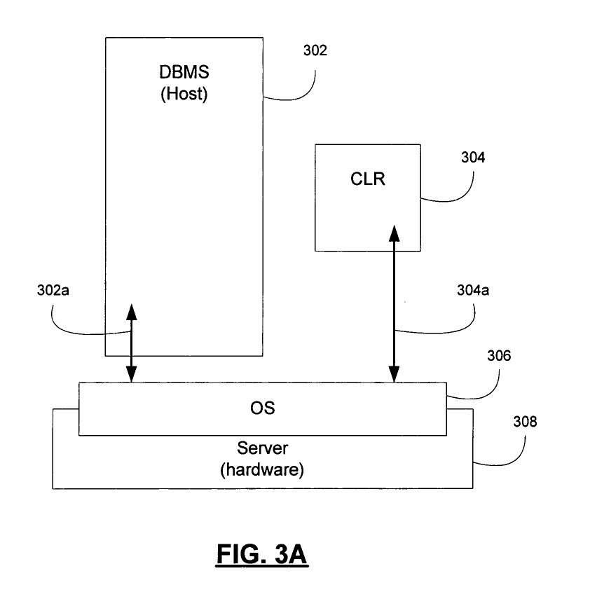

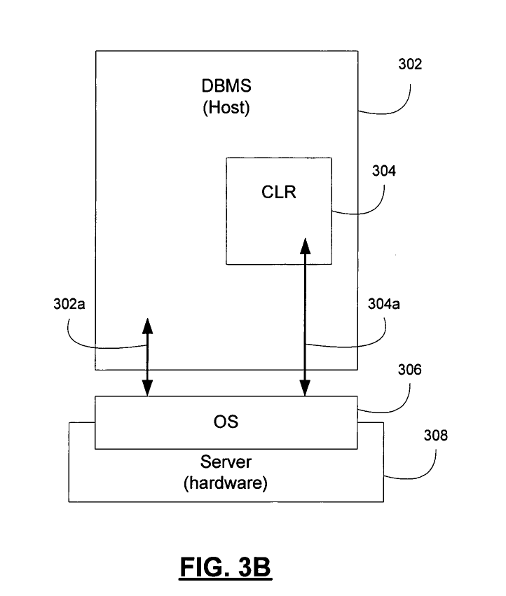

Both a DBMS and a CLR can run on the same server, either side by side as illustrated in FIG. 3A, or the CLR may run within the same space as the DBMS as illustrated in FIG. 3B. In both figures, the DBMS 302 and the CLR 304 can directly interface 302a and 304a with the server operating system 306 that is running on the server 308. Therefore, in either configuration, both the DBMS 302 and the CLR 304 can operate without regard for the other except to the extent controlled and regulated by the server operating system 306. However, this leads to a plurality of shortcomings that are discussed in greater detail later herein. (Hereinafter, this approach is referred to as the “Unhosted Approach.”)

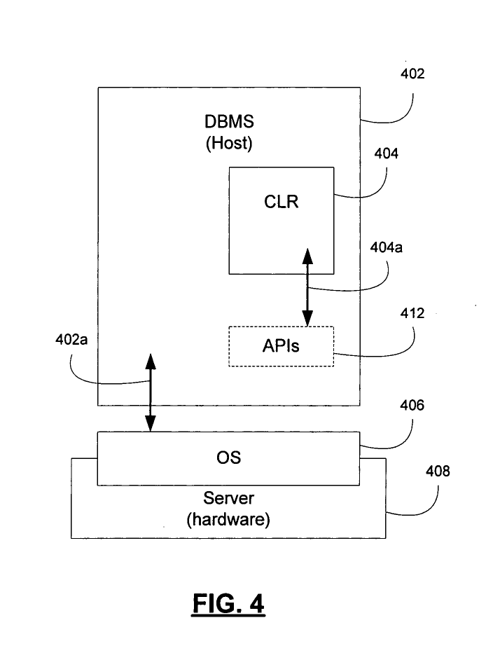

In contrast, for the various embodiments of the present invention, and as illustrated in FIG. 4, the CLR 404 is hosted inside the DBMS 402 and, instead of making requests directly to the server operating system 306, the CLR 404 instead interfaces 404a with the DBMS 402 via DBMS APIs 412 for such requests, and only the DBMS 402 interfaces 402a with the server operating system 406 to access the server 408. (Hereinafter, this approach is referred to as the “Hosted Approach.”)

When operating independently, as in the Unhosted Approach, both the DBMS and CLR manage memory, threads, and synchronization between multiple threads, but these endeavors are not coordinated. On the other hand, when operating in cooperation with each other, as in the Hosted Approach, the CLR is subordinated to the DBMS in order to provide for the greater benefit to both. In these embodiments, the DBMS has a single integrated view of all the memory, threads, and synchronization activity that is happening in the system, and the CLR is subordinated to the DBMS—that is, the DBMS provides the memory and thread resources and also the synchronization services needed by the CLR, and the CLR calls APIs implemented by the DBMS to (i) allocate and free memory, (ii) create and destroy threads, and (iii) synchronize access to data structures shared between multiple threads.

The specific advantages of the Hosted Approach over the Unhosted Approach are in regards to the characteristics of security, robustness, performance, and scalability comprise improvements to memory management, threading, security controls, and handling performance-related issues.

Memory Management

In regard to memory, the DBMS attempts to manage memory resources such that, to the extent possible, it is only using physical memory. This provides optimum performance and better prediction by the query optimizer of query execution time. In the Unhosted Approach, the DBMS has an incomplete understanding of the total memory being used by the system because it is unaware of memory allocated to CLR, and thus can not enforce limits on the total memory used. Conversely, in the Hosted Approach, the DBMS has a complete understanding of the total memory being used by the system—be it allocated directly by the DBMS or by CLR through the DBMS APIs—and thus the DBMS is able to enforce limits on the total memory used.

Threading & Synchronization

In regard to managing threads, the DBMS wants to ensure that only one thread is running per processor in order to minimize the overhead associates with thread switching. A problem with the Unhosted Approach, however, is that each the CLR and the DBMS can create their own threads, and thus multiple threads can be assigned to a single processor. In contrast, in the hosted Approach the DBMS has a complete picture of all the threads in the system and can insure only one is executing on each processor at a time.

In addition, all synchronization resources acquired by threads executing in CLR are acquired through the DBMS. This enables CLR threads to execute non-preemptively, which increases performance dramatically. This also allows the DBMS to detect deadlocks that include synchronization resource acquired by CLR, and employ traditional techniques for deadlock removal based on this detection.

Security

In regard to security, and using the Unhosted Approach where the CLR operates outside of the DBMS, managed code (that is, IL code being executed by a CLR) can generally access system resources (such as files, network etc.) that are not directly managed by the DBMS.

In contrast, for several embodiments of the present invention where the CLR is running in the DBMS using the Hosted Approach, the DBMS controls access to restricted resources and prevent unauthorized access by managed code when appropriate. Furthermore, certain operations that can be done by managed code (for example, calling the API to exit the current process, call an API that creates a GUI Window etc.), when executed from inside of the DBMS, can impair the stability or robustness of the DBMS server process itself, but these problems are circumvented when hosting the CLR in the DBMS and allowing the DBMS to manage such operations. Thus, several embodiments of the present invention are directed to enabling the DBMS to control whether managed code can access resources external to the DBMS and whether/when/where managed code can perform operations that can potentially impact the robustness of the DBMS.

The CLR provides a mechanism called Code Access Security (CAS) that allows its host to specify restrictions on what operations that managed code can or cannot do. The restrictions are specified in the form of a Security Policy that is established for every application domain that runs managed code within the host. It is through this CAS mechanism that enables the DBMS present invention to enhance the security of the system.

For various embodiments of the present invention where the CLR hosted by the DBMS, when managed code deployment units (called assemblies) are created they may be assigned one of three permission buckets: SAFE, EXTERNAL_ACCESS and UNSAFE. Assemblies in the SAFE bucket are only allowed computational and data access inside the DBMS but are not allowed to access resources external to the DBMS, nor are such Assemblies allowed to perform operations that can potentially impact the integrity of the DBMS process (“unsafe operations”). Assemblies in the EXTERNAL_ACCESS bucket have access similar to SAFE Assemblies except EXTERNAL_ACCESS assemblies also have access to external resources. Assemblies in the UNSAFE bucket have both access to external resources and are allowed to perform unsafe operations; however, given the nature of such assemblies, only highly trusted DBMS users are allowed to create assemblies with this permission set. In various alternative embodiments, the DBMS may also set up a Security Policy (SP) on every application domain created by the DBMS. This SP would identify assemblies being loaded in the database and, based on the permission set specified for the assembly (e.g., the three permission buckets), grant only the set of Code Access Security permissions corresponding to that set.

Reliability: Performance and Robustness

In regard to reliability—comprising elements of both robustness and performance—when managed code encounters resource failures (such as out-of-memory, stack overflow) in the hosted CLR, the DBMS can ensure that these failures do not compromise the consistency of data (both persisted data in the DBMS or in memory data structures) that is managed by the CLR or the DBMS. Moreover, the DBMS cam also ensure that resource failures cause minimal disruption in the user application for managed code in the SAFE or EXTERNAL_ACCESS buckets.

Managed code cannot predict when stack overflow (SO), out of memory (OOM), thread abort (TA) errors will occur, and thus for an unhosted CLR it is very difficult to write managed back-out code that guarantees consistency of any shared state. However, in various embodiments of the present invention, and in cooperation with the DBMS, the CLR engine is designed to abort the session that encountered the resource failure and, if that session had any locks, the entire application domain that session is in is unloaded. (This is because having locks indicates there is some shared state to synchronize, and thus there is shared state that likely will not be consistent if just the session that encountered the failure were aborted.) This is achieved by the following mechanisms:
The DBMS notifies CLR that if it encounters any resource failures, to unload the application domain if any locks are held. This will abort any application transactions that are currently running in that application domain, and then the applications can resubmit their transaction upon receiving the transaction abort error. In this way, the consistency and correctness of the application is guaranteed.
When SAFE and EXTERNAL_ACCESS assemblies are created, the DBMS ensures that they do not contain updateable static fields in the classes defined in the assembly, and that they do not use synchronization APIs. This reduces the likelihood of state being shared across concurrent user sessions that are running in the DBMS. Discouraging shared states in this way reduces the number of cases when application domains have to be unloaded (and user sessions aborted)—as per the previous method—and thus increases application throughput.
   Hosting the CLR in the DBMS

Lastly, the following is a list of hosting APIs that may be utilized by several embodiments of the present invention:
CLR Initialization: CorBindToRuntimeEx may be used to lock down a specific CLR version that is allowed to run inside SQL. ICLRRuntimeHost may be used to start and stop the runtime and manage application domains.
Memory: IHostMemoryManager and ICLRMemoryNotificationCallback may be used to request the CLR to free memory. IHostMalloc and ICLRGCManager may be used to by the host to force GC.
Threading: ICLRTask, IHostTask ICLRTaskManager, and IHostTaskManager may be used to schedule and abort threads and fibers. ICLRIoCompletionManager and IHostIoCompletionManager may be used for asynchronous input/output.
Synchronization and Events: IHostSyncManager may be used to enable creation of synchronization objects. IHostAutoEvent, IHostManualEvent, IHostSemaphore, and IHostCrst may be used for events, semaphores, and critical sections. ICLRSyncManager may be used to provide info on synchronization objects.
Assembly Loading: IHostAssemblyManager may be used to intercept assembly loading activity and apply a host assembly load policy.
Reliability and Escalation Policy During Failures: ICLRPolicyManager, ICLRHostProtectionManager, IHostPolicyManager, and IActionOnCLREvent may be used for this purpose.
Debugging: ICLRDebugManager may be used to facilitate debugging.
   Conclusion

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of digital devices emulating the functionality of personal computers, one skilled in the art will recognize that the present invention is not limited to such digital devices, as described in the present application may apply to any number of existing or emerging computing devices or environments, such as a gaming console, handheld computer, portable computer, etc. whether wired or wireless, and may be applied to any number of such computing devices connected via a communications network, and interacting across the network. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

Finally, the disclosed embodiments described herein may be adapted for use in other processor architectures, computer-based systems, or system virtualizations, and such embodiments are expressly anticipated by the disclosures made herein and, thus, the present invention should not be limited to specific embodiments described herein but instead construed most broadly. Likewise, the use of synthetic instructions for purposes other than processor virtualization are also anticipated by the disclosures made herein, and any such utilization of synthetic instructions in contexts other than processor virtualization should be most broadly read into the disclosures made herein.

1. A method for coordinating the operation of a database management system and a common language runtime executing on a common server, said method comprising the database management system hosting the common language runtime wherein the common language runtime executes requests for at least one system resource via an application programming interface of the database management system.

2. The method of claim 1 wherein said at least one system resource is a memory resource.

3. The method of claim 2 wherein
said common language runtime requests a memory resource via the application programming interfaces of the database management system,
said database management system coordinates the request with:
at least one other request on a memory management system for said database management system, and
a current state of memory on the database management system,
to ensure the database management system and the common language runtime use only physical memory to execute said requests.

4. The method of claim 2 wherein said common language runtime requests a memory resource via the application programming interfaces of the database management system, and the database management system manages the request to allocate a block of physical memory where, had the common language runtime requested said memory resource directly from an associated operation system, the common language runtime would have been allocated a block of virtual memory.

5. The method of claim 1 wherein said database management system requests an allocation of memory from an associated operating system where said request is made on behalf of said common language runtime.

6. The method of claim 1 wherein said at least one system resource is an execution of a first thread.

7. The method of claim 6 wherein said common language runtime requests an execution of a first thread via the application programming interfaces of the database management system, and the database management system manages the request to assign the first thread to a processor, ensure it is the only thread executing on that processor, and execute it non-preemtively where, had the common language runtime requested said execution of said first thread directly from an associated operation system, the first thread would have been allocated to a processor preemptively and may not have been the only thread executing on that processor.

8. The method of claim 1 wherein said database management system requests an execution of a first thread from an associated operating system where said request is made on behalf of said common language runtime.

9. The method of claim 1 wherein said at least one system resource is a secured data resource.

10. The method of claim 9 wherein said common language runtime requests a secured data resource via the application programming interfaces of the database management system, and the database management system manages the request to grant or deny access to said data resource based on a predefined criteria.

11. The method of claim 1 wherein said database management system requests a secured data resource from an associated operating system where said request is made on behalf of said common language runtime.

12. The method of claim 1 further comprising said database management system providing the common language runtime with a security policy that governs:
whether a set of resources can be accessed by an execution code running in said common language runtime; and
whether a set of operations can be performed by said execution code running in said common language runtime.

13. The method of claim 12 further comprising said database management system enabling said execution code to specify a set of Code Access Security (CAS) permissions that are used by the database management system to:
determine whether said execution code is permitted to access a specific resource outside of the control of the database management system; and
specify whether said execution code is permitted to perform operations that are identified as potentially compromising a measurement of robustness of a process operating in said database management system.

14. The method of claim 13 further comprising:
setting up a security policy that governs the common language runtime; and
enforcing the set of Code Access Security (CAS) permissions.

15. A system for coordinating the operation of a database management system and a common language runtime executing on a common server, said system comprising a subsystem by which the database management system hosts the common language runtime, wherein the common language runtime executes requests for at least one system resource via an application programming interface of the database management system.

16. The system of claim 15 wherein said at least one system resource is a memory resource.

17. The system of claim 16 further comprising a subsystem whereby:
said common language runtime requests a memory resource via the application programming interfaces of the database management system,
said database management system coordinates the request with:
at least one other request on a memory management system for said database management system, and
a current state of memory on the database management system,
to ensure the database management system and the common language runtime use only physical memory to execute said requests.

18. The system of claim 16 wherein said common language runtime requests a memory resource via the application programming interfaces of the database management system, and the database management system manages the request to allocate a block of physical memory where, had the common language runtime requested said memory resource directly from an associated operation system, the common language runtime would have been allocated a block of virtual memory.

19. The system of claim 15 wherein said database management system requests an allocation of memory from an associated operating system where said request is made on behalf of said common language runtime.

20. The system of claim 15 wherein said at least one system resource is an execution of a first thread.

21. The system of claim 20 wherein said common language runtime requests an execution of a first thread via the application programming interfaces of the database management system, and the database management system manages the request to assign the first thread to a processor, ensure it is the only thread executing on that processor, and execute it non-preemtively where, had the common language runtime requested said execution of said first thread directly from an associated operation system, the first thread would have been allocated to a processor preemptively and may not have been the only thread executing on that processor.

22. The system of claim 15 wherein said database management system requests an execution of a first thread from an associated operating system where said request is made on behalf of said common language runtime.

23. The system of claim 15 wherein said at least one system resource is a secured data resource.

24. The system of claim 23 wherein said common language runtime requests a secured data resource via the application programming interfaces of the database management system, and the database management system manages the request to grant or deny access to said data resource based on a predefined criteria.

25. The system of claim 15 wherein said database management system requests a secured data resource from an associated operating system where said request is made on behalf of said common language runtime.

26. The system of claim 15 further comprising a subsystem by which said database management system provides the common language runtime with a security policy that governs:
whether a set of resources can be accessed by an execution code running in said common language runtime; and
whether a set of operations can be performed by said execution code running in said common language runtime.

27. The system of claim 26 further comprising a subsystem for said database management system to enable said execution code to specify a set of Code Access Security (CAS) permissions that are used by the database management system to:
determine whether said execution code is permitted to access a specific resource outside of the control of the database management system; and
specify whether said execution code is permitted to perform operations that are identified as potentially compromising a measurement of robustness of a process operating in said database management system.

28. The system of claim 27 further comprising:
a subsystem for setting up a security policy that governs the common language runtime; and
a subsystem for enforcing the set of Code Access Security (CAS) permissions.

29. A computer-readable medium comprising computer-readable instructions for coordinating the operation of a database management system and a common language runtime executing on a common server, said computer-readable instructions comprising instructions for the database management system to host the common language runtime whereby the common language runtime executes requests for at least one system resource via an application programming interface of the database management system.

30. The computer-readable instructions of claim 29 further comprising instructions whereby at least one system resource is a memory resource.

31. The computer-readable instructions of claim 30 further comprising instructions whereby:
said common language runtime requests a memory resource via the application programming interfaces of the database management system,
said database management system coordinates the request with:
at least one other request on a memory management system for said database management system, and
a current state of memory on the database management system,
to ensure the database management system and the common language runtime use only physical memory to execute said requests.

32. The computer-readable instructions of claim 30 further comprising instructions whereby common language runtime requests a memory resource via the application programming interfaces of the database management system, and the database management system manages the request to allocate a block of physical memory where, had the common language runtime requested said memory resource directly from an associated operation system, the common language runtime would have been allocated a block of virtual memory.

33. The computer-readable instructions of claim 29 further comprising instructions whereby database management system requests an allocation of memory from an associated operating system where said request is made on behalf of said common language runtime.

34. The computer-readable instructions of claim 29 further comprising instructions whereby at least one system resource is an execution of a first thread.

35. The computer-readable instructions of claim 34 further comprising instructions whereby said common language runtime requests an execution of a first thread via the application programming interfaces of the database management system, and the database management system manages the request to assign the first thread to a processor, ensure it is the only thread executing on that processor, and execute it non-preemtively where, had the common language runtime requested said execution of said first thread directly from an associated operation system, the first thread would have been allocated to a processor preemptively and may not have been the only thread executing on that processor.

36. The computer-readable instructions of claim 29 further comprising instructions whereby database management system requests an execution of a first thread from an associated operating system where said request is made on behalf of said common language runtime.

37. The computer-readable instructions of claim 29 further comprising instructions whereby at least one system resource is a secured data resource.

38. The computer-readable instructions of claim 37 further comprising instructions whereby common language runtime requests a secured data resource via the application programming interfaces of the database management system, and the database management system manages the request to grant or deny access to said data resource based on a predefined criteria.

39. The computer-readable instructions of claim 29 further comprising instructions whereby database management system requests a secured data resource from an associated operating system where said request is made on behalf of said common language runtime.

40. The computer-readable instructions of claim 29 further comprising instructions whereby said database management system provides the common language runtime with a security policy that governs:
whether a set of resources can be accessed by an execution code running in said common language runtime; and
whether a set of operations can be performed by said execution code running in said common language runtime.

41. The computer-readable instructions of claim 40 further comprising instructions whereby said database management system enables said execution code to specify a set of Code Access Security (CAS) permissions that are used by the database management system to:
determine whether said execution code is permitted to access a specific resource outside of the control of the database management system; and
specify whether said execution code is permitted to perform operations that are identified as potentially compromising a measurement of robustness of a process operating in said database management system.

42. The computer-readable instructions of claim 41 further comprising instructions for:
setting up a security policy that governs the common language runtime, and
enforcing the set of Code Access Security (CAS) permissions.
